(19) United States
(12) Patent Application Publication
(10) Pub. No.: US 2024/0158158 A1
(43) Pub. Date: May 16, 2024

(54) CARTRIDGE FOR THE PREPARATION OF LIQUID PRODUCTS

(71) Applicant: LUIGI LAVAZZA S.P.A., Torino (IT)

(72) Inventors: Danilo BOLOGNESE, Torino (IT); Chiara BRANDONISIO, Torino (IT); Silvia BARUS, Torino (IT)

(21) Appl. No.: 18/550,670

(22) PCT Filed: Feb. 15, 2022
(86) PCT No.: PCT/IB2022/051335

§ 371 Date: Sep. 14, 2023

(30) Foreign Application Priority Data
Mar. 15, 2021 (IT) 102021000006086

(51) Int. Cl. B65D 85/804; B65D 65/42; B65D 65/46

(52) U.S. Cl. CPC B65D 85/8043; B65D 65/42; B65D 65/466; B65D 2565/381

(57) ABSTRACT

Cartridge (10) with a filling (12) of at least one substance for preparing a liquid product, said cartridge (10) including a side wall (140), a first end wall (142) through which said liquid product can flow from the cartridge (10) and a second end wall (16) of the cartridge (10) at the opposite side with respect to said first end wall (142), wherein said side wall (140), said first end wall (142) and said second end wall (16) comprise compostable material. The at least one between said first end wall (142) and said second end wall (16) has a layered structure comprising at least one layer (1420) of a first compostable material and at least one layer (1422) of a second compostable material, wherein said at least one layer (1420) of a first compostable material comprises at least one compound selected between polybutyrate adipate terephthalate (PBAT) and polybutylsuccinate (PBS), wherein said at least one layer (1422) of a second compostable material consists of at least one compound selected between polylactic acid (PLA) and a polyhydroxyalkanoate (PHA) polymer, wherein the polyhydroxyalkanoate (PHA) polymer is preferably polyhydroxybutyrate (PHB).

### TECHNICAL FIELD

The present description relates to cartridges for the preparation of liquid products.

One or more embodiments may refer to cartridges for the preparation of beverages, such as coffee or tea.

### TECHNOLOGICAL BACKGROUND

Cartridges for the preparation of liquid products, such as beverages, via introduction of liquid (possibly under pressure and/or at a high temperature) and/or vapour constitute a technological sector that is extremely rich and articulated. As regards preparation of coffee there are known, for example from the document EP-A-0 507 905, solutions that enable preparation of espresso coffee.

Documents such as EP 2 648 579 A1 or else EP 3 507 215 A1 exemplify the possibility of using, to produce at least part of the aforesaid cartridges, compostable materials.

EP 2 648 579 A1 describes a cartridge comprising a bottom wall that has a layered structure with at least one layer of a first compostable material that is liable to undergo softening and/or melting at a temperature comprised in the range between 70° C. and 120° C., and at least one layer of a second compostable material that does not undergo noticeable softening and/or melting at such temperatures.

EP 3 507 215 A1 describes a compostable cartridge, in which at least one between the bottom wall and the closing wall has a layered structure comprising a coating layer that forms a barrier to oxygen and water vapour.

The characteristics of a compostable material, according to a definition that is commonly accepted also at the patent level, are currently established by the European norm EN 13432 “Packaging—Requirements for packaging recoverable through composting and biodegradation—Test scheme and evaluation criteria for the final acceptance of packaging”, adopted also in Italy under UNI EN 13432. Capsules or cartridges for the preparation of coffee (or tea or other liquid products, such as beverages) that are compostable according to UNI EN 13432 can be disposed of by organic recycling (composting), for example envisaging that the so-called spent cartridges will undergo a process of disintegration within a pre-set time period (3 months).

Polylactic acid (PLA), a polymer that can be obtained from renewable sources, such as maize, potatoes, and sugar cane, today represents one of the compostable materials that are most widely used. For the application considered here, however, this material may present critical aspects. During preparation of a beverage, such as coffee or espresso coffee, the liquid and/or the vapour introduced into the cartridge may be at temperatures of approximately 100° C. and at pressures even higher than 10 atm. It follows that the polylactic acid, as example of compostable material, may undergo phenomena of softening or melting, consequently hindering flow of the beverage. The adoption of the solution of perforating the side where the water enters and the side where the coffee exits presents the advantage of generating a pre-brewing of the beverage, which is useful for extracting the substances contained in the roasted and ground coffee but simultaneously poses a technical challenge in the production of entirely compostable cartridges.

To overcome the aforesaid critical features, solutions may be adopted that envisage recourse to the use of polymeric blends, where the PLA is mixed with other biopolymers in order to obtain a material having the desired characteristics.

In particular, for the application considered herein it is possible to use compostable materials that comprise PLA in combination with other biopolymers, such as polybutyrate adipate terephthalate (PBAT) and polybutylsuccinate (PBS). These materials, which are suitable for bestowing a greater thermomechanical strength on the walls of the cartridge during dispensing the beverage, may, however, present the disadvantage of releasing traces of contaminating substances that inevitably come into contact with the foodstuff product contained in the cartridge.

Consequently, characteristics of compostability (i.e., the capacity of the material and of the product to be modified by the surrounding environment in the sense of chemico-physical degradation), of thermomechanical strength in conditions of delivery in the coffee machine, and of impermeability to contaminating substances may not easily coexist in one and the same product.

### OBJECT AND SUMMARY

The object of one or more embodiments of the present disclosure is to overcome the aforesaid drawbacks.

According to one or more embodiments, the above object is achieved thanks to a cartridge having the characteristics recalled in claim 1, in particular a cartridge containing a dose of at least one substance for preparing a liquid product, said cartridge comprising a side wall, a first end wall, through which said liquid product can flow from the cartridge, and a second end wall of the cartridge at the end opposite to said first end wall, wherein said side wall, said first end wall, and said second end wall comprise compostable material. At least one between said first end wall and said second end wall has a layered structure comprising at least one layer of a first compostable material and at least one layer of a second compostable material. The at least one layer of a first compostable material comprises at least one compound selected between polybutyrate adipate terephthalate (PBAT) and polybutylsuccinate (PBS). The at least one layer of a second compostable material consists of at least one compound selected from among PLA, a polyhydroxyalkanoate (PHA) polymer, polyhydroxy butyrate (PHB), or combinations thereof.

The claims form an integral part of the technical teaching provided herein in relation to the embodiments.

### BRIEF DESCRIPTION OF THE DRAWINGS

One or more embodiments will now be described, purely by way of non-limiting example, with reference to the annexed drawings, wherein:

FIG. 1 is a perspective broken view of a cartridge according to some embodiments;

FIG. 2 is a perspective broken view of a cartridge according to some embodiments;

FIG. 3 is a schematic cross-sectional view at an enlarged scale of the detail indicated by the arrow III in FIG. 2, in particular of the bottom wall of a cartridge according to some embodiments; and

FIG. 4 illustrates a histogram regarding experimental tests conducted in order to verify migration of volatile cyclic ethers from the walls of the cartridge into the latter.

### DETAILED DESCRIPTION

In the ensuing description, various specific details are illustrated aimed at enabling an in-depth understanding of examples of embodiments of the present disclosure. The embodiments may be obtained without one or more of the specific details or with other methods, components, materials, etc. In other cases, known structures, materials, or operations are not illustrated or described in detail so that the various aspects of the embodiments will not be obscured.

Reference to “an embodiment” or “one embodiment” in the framework of the present description is intended to indicate that a particular configuration, structure, or characteristic described in relation to the embodiment is comprised in at least one embodiment. Hence, phrases such as “in an embodiment” or “in one embodiment” that may be present in different points of this description do not necessarily refer to one and the same embodiment. Moreover, particular conformations, structures, or characteristics may be combined in any adequate way in one or more embodiments.

The references used herein are provided merely for convenience and hence do not define the sphere of protection or the scope of the embodiments.

The Inventors of the present patent application have provided a compostable cartridge for which the choice of the materials, the specific distribution and the thickness thereof render it particularly suited for the application considered herein. The cartridge forming the subject of the present disclosure, albeit made of compostable material, presents characteristics of resistance to the thermomechanical stresses that are set up during dispensing of the beverage. At the same time, experimental tests conducted by the Inventors have demonstrated that the phenomenon of migration of undesirable substances, such as lactides, diols and volatile cyclic ethers, from the walls of the cartridge into the chamber that contains the dose for preparing the liquid product is significantly hindered.

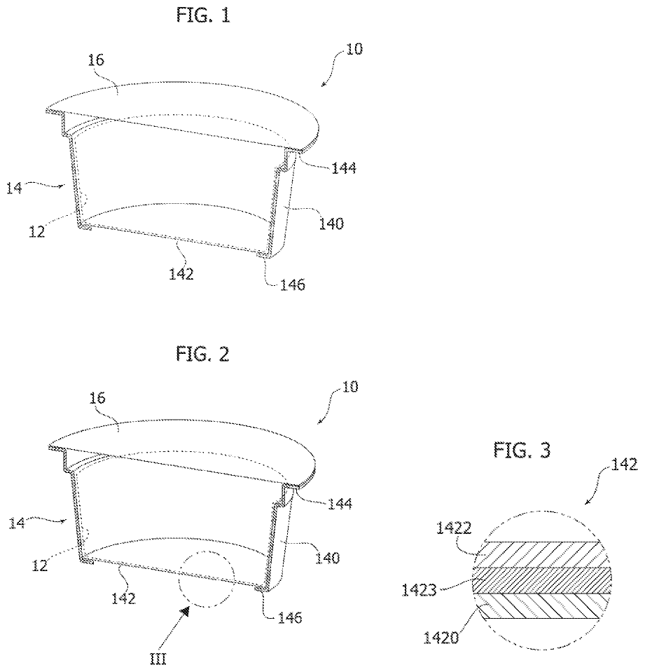

Illustrated by way of example in FIG. 1 is the general structure of a cartridge (or capsule, according to another current definition) suitable for implementing the present technical solution.

The cartridge, indicated by the reference number 10, comprises a body 14, which defines a chamber for containing a dose of a substance suitable to form a liquid product using water and/or vapour. The liquid product in question may be a beverage such as coffee (for example espresso coffee) or tea, for example obtained by introducing into the cartridge liquid and/or vapour under pressure and at a high temperature. In various embodiments, the dose 12 may be constituted by ground coffee or by another precursor of a liquid product such as a beverage, tea, chocolate in powdered or granular form, products for the preparation of broth, soup, drinks, and infusions of various nature: this list is to be understood as being provided purely of non-binding example.

The body of the cartridge, designated as a whole by the reference number 14, may comprise:
a side wall 140 of a compostable material;
a first end wall (bottom wall) 142 and a second end wall (top wall or closing wall) 16 of compostable material.

In one or more embodiments, the material of the closing wall 16 may be suited to being connected in a sealed way, for example by heat-sealing, to the side wall 140 of the body 14 of the cartridge, for example at a flange 144 that surrounds the mouth part of the aforesaid body 140. In one or more embodiments, the material of the bottom wall 142 may be suited to being connected in a sealed way, for example by heat-sealing, to the side wall 140 of the body 14 of the cartridge, for example at a flange 146 that extends towards the inside of the bottom part of the body 140. In one or more embodiments, the bottom wall 142 may be made of a single piece with the side wall 140.

In one or more embodiments as exemplified herein, the bottom wall 142 may be plane or substantially plane or else present a vault-like conformation, for example concave with the concavity facing the outside or the inside of the cartridge 10. The structure of the closing wall 16 and of the bottom wall 142 may be rendered symmetrical so as to enable dispensing of the beverage independently either from one side or from the other, this being an option of differentiation useful for the design of the apparatus that has the function of dispensing the beverage from the capsule.

In one or more embodiments, the body 14 may present a tray-like conformation diverging from the bottom wall 142 towards the closed end of the closing wall 16. The diverging conformation may, for example, be a frustoconical conformation. This conformation is not on the other hand imperative in so far as the cartridge 10 may present as a whole different shapes, for example a prismatic shape, a frustopyramidal shape, etc.

The sequence of use of the cartridge 10 may substantially be likened to the sequence of use of the cartridge described in EP A 0 507 905 A1 or in WO 2012/077066 A1. This sequence of use, which is to be understood as being provided purely by way of example and such as to allow for different variants, is to be deemed in itself known, which renders any more detailed description thereof superfluous.

Forming the subject of the present description is a cartridge 10, as for example the one illustrated in FIGS. 1-3, wherein at least one of the two end walls 142 and 16 comprises a layered structure comprising at least one layer 1420 of a first compostable material and at least one layer 1422 of a second compostable material.

In particular, the layer 1420 of a first compostable material comprises at least one compound chosen from among polybutyrate adipate terephthalate (PBAT), polybutylsuccinate (PBS), combinations thereof.

The layer 1420 of a first compostable material may comprise further compounds, such as polylactic acid (PLA), polyhydroxyalkanoate (PHA) polymers, preferably polyhydroxybutyrate (PHB), combinations thereof.

In a preferred embodiment, the at least one layer 1420 of a first compostable material comprises, preferably consists of, a mixture of PBAT and/or PBS in combination with PLA.

The at least one layer 1422 of a second compostable material consists of at least one compound selected between PLA and a polyhydroxyalkanoate (PHA) polymer, preferably PHB.

The at least one layer 1422 of a second compostable material may consist of PLA.

In a preferred embodiment, the at least one layer 1422 of a second compostable material is arranged internally (faces the inside) of the cartridge with respect to the layer 1420 of a first compostable material, in particular the at least one layer 1422 of a second compostable material is in contact with the substance for preparing the liquid product.

In one or more embodiments, the layered structure of the first end wall 142 and/or of the second end wall 16 may comprise:
at least one layer 1420 of said first compostable material;
a layer 1422 of said second compostable material, preferably consisting of PLA, which faces the outside of the cartridge 10 with respect to the layer 1420 of said first compostable material; and
a layer 1422 of said second compostable material, preferably consisting of PLA, which faces the inside of the cartridge with respect to the layer 1420 of said first compostable material in contact with the substance for preparing the liquid product.

The thickness of said first end wall 142 (bottom wall) and said second end wall 16 (closing wall) may be comprised between 120 μm and 1000 μm.

The thickness of said at least one layer 1420 of a first compostable material is comprised between 50% and 80% of the total thickness of each one between said first end wall 142 and said second end wall 16.

The thickness of said at least one layer 1422 of a second compostable material is comprised between 20% and 50% of the total thickness of each one between said first end wall 142 and said second end wall 16.

In one or more embodiments, the ratio between the thickness of said at least one layer 1420 of a first compostable material and the thickness of said at least one layer 1422 of a second compostable material is 4:1.

In one or more embodiments, the layered structure of the first end wall 142 and/or of the second end wall 16 comprises, preferably consists of, at least one layer 1420 of said first compostable material and a layer 1422 of said second compostable material, preferably consisting of PLA. In this embodiment, the ratio between the thickness of said at least one layer 1420 of a first compostable material and the thickness of said layer 1422 of said second compostable material, preferably consisting of PLA, is 4:1.

In one or more embodiments, at least one of the two end walls, preferably the bottom wall 142, comprises the layered structure forming the subject of the present description.

In one or more embodiments, the closing wall 16 may comprise cellulose, and its derivatives, such as for example cellophane, PLA, or combinations thereof.

In one or more embodiments, the closing wall 16 may comprise a layered structure including a layer of white paper (35±3.5 g/m²), a layer of metallized cellulose (20±2 μm; 29±2.9 g/m²), a PLA sealing layer (40±4 μm; 49.6±5 g/m²).

The side wall of the cartridge may be obtained with a compostable material selected in the group consisting of paper, cellophane, cellulose, polymers extracted from biomass, synthetic polymers, polymers produced by micro-organisms or by genetically modified bacteria, polymers from fossil monomers, polyanhydrides, polyvinyl alcohol, and combinations thereof.

The Inventors of the present patent application have noted that the choice of i) the specific compostable materials, ii) the thickness of the layers, and iii) their specific distribution provides a cartridge that has a thermomechanical strength such as to render it suitable for the application considered herein. At the same time, the aforesaid combination of characteristics provides a cartridge in which migration of undesired substances from the cartridge to the foodstuff product contained therein is significantly hindered. Such undesired substances may derive from degradation, impurities, oligomers of the compostable material used in the layer 1420 comprising at least one compound chosen from among polybutyrate adipate terephthalate (PBAT), polybutylsuccinate (PBS), and corresponding mixtures thereof. Such undesired substances may comprise, for example, lactides, diols, and volatile cyclic ethers.

In particular, the at least one layer 1420 of the first compostable material confers to the end wall the structural characteristics that make it possible to prevent, during perforation, the cartridge from rupturing in a random way or else the orifices provided in the means, such as needles or tips aimed at performing the perforation operation, from getting clogged, thus hindering outflow of the beverage.

The at least one layer 1422 of the second compostable material has proven surprisingly suited to exerting a barrier function, in regard to the passage of the aforesaid undesired substances that are liable to migrate and to present volatility and may upset the taste and/or organoleptic characteristics, from the layer 1420 of the first compostable material towards the inside of the cartridge 16.

In one or more embodiments, the at least one layer 1420 of the first compostable material may be coated with the at least one layer 1422 of the second compostable material. This coating may be obtained, for example, by means of spraying, co-extrusion, spreading of a layer of PLA with the possible use of lacquer.

In one or more embodiments, at least one between the first end wall 142 and the second end wall 16 of the cartridge may present at least one coating layer 1423 forming a barrier to oxygen and water vapour sandwiched between the layer of a first compostable material 1420 and the layer 1422 of a second compostable material. The presence of such a barrier coating 1423 makes it possible to favour maintenance of the characteristics of the foodstuff product, the integrity of which could be altered during the period of conservation.

In one or more embodiments, the side wall may be free (without) barrier coating layers.

In one or more embodiments, materials that may be used to produce the coating layer/layers with barrier effect in regard to oxygen and humidity may be chosen from polymeric materials commonly used in the packaging sector. Such coating layers may, for example, be chosen from among metallization layers, silicon-based and/or silicon-oxide-based coatings, aluminium-based and/or aluminium-oxide-based coatings, polyvinyl alcohol (PVOH), butane-diol-vinyl alcohol co-polymer (BVOH, “G polymer”), or combinations thereof. As an example of the possibility of coupling a compostable polymeric material to at least one barrier coating layer it is possible to cite the product having the brand name Natureflex™ NM, marketed by Innovia Films.

FIG. 3 illustrates a detail of the layered structure of the bottom wall 142 of a cartridge according to one or more embodiments, for example illustrated in FIG. 2. The proportions between the thicknesses of the layers that make up the bottom wall are emphasized in the figures with the sole purpose of rendering the latter clearer.

In particular, FIG. 3 illustrates the bottom wall 142 comprising a layered structure with a layer 1420 of a first compostable material comprising a mixture of PLA and PBS and a layer 1422 of a second compostable material consisting of PLA. Said layer 1422 of a second compostable material consisting of PLA is arranged internally of the cartridge with respect to the layer 1420 of the first compostable material and is in contact with the substance for preparing a liquid product.

A barrier coating 1423 against oxygen and water vapour is set between the layer 1420 and the layer 1422. The thickness of the layer 1423 is greater than or equal to 30 μm.

The closing wall 16 of the cartridge illustrated in FIG. 2 may comprise a layered structure similar to that of the bottom wall 142 (where the layer 1422 consisting of PLA faces the inside of the cartridge, in contact with the substance that can be used for preparing a liquid product), or else comprise, for example, a paper layer, a cellulose layer, a PLA layer (once again with the PLA layer that faces the inside of the cartridge).

At the production level, one or more embodiments may envisage injection moulding of the side wall 140 and subsequent sealing (for example heat-sealing) of the end walls 142, 16.

### Examples

Migration Tests—Comparative Analyses

A first set of compostable capsules in which the bottom wall consisted of a layer of compostable material consisting of a mixture of PLA and PBS and a second set of compostable capsules in which the bottom wall comprises a layer 1420 of a first compostable material consisting of a mixture of PLA and PBS and a layer 1422 of a second compostable material consisting of PLA, set facing the inside of the cartridge in contact with the coffee powder according to what is envisaged by the invention, were subjected to accelerated-migration tests.

The tests were conducted on capsules kept at a temperature of 60° C. for up to 10 days (conditions of accelerated migration).

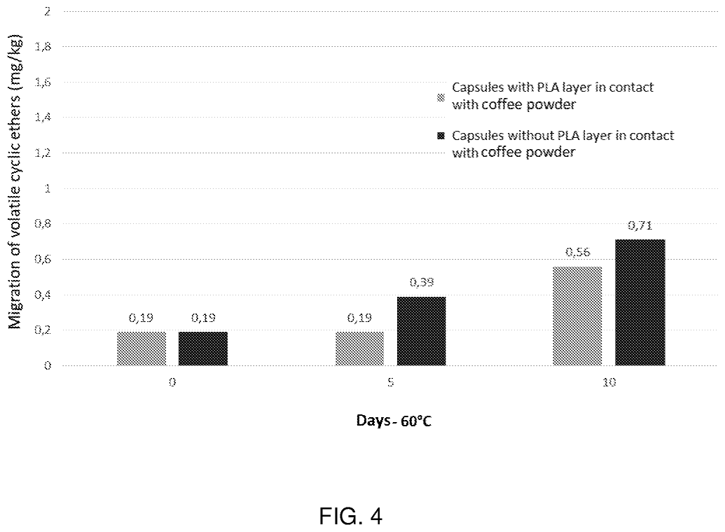

The experimental analyses were conducted by testing the content, using the technique of headspace gas-chromatography/mass-spectrometry (HS-GC-MS) analysis in order to identify the presence of volatile cyclic ethers within the capsules, i.e., in the coffee powder and also in the beverage. FIG. 4 shows the migration towards the coffee powder.

The capsules comprising the PLA layer in contact with the coffee powder presented lower values of migration of the volatile cyclic ethers as compared to the case where the PLA layer was not present, both after 5 days and after 10 days.

Without prejudice to the underlying principle, the details of construction and the embodiments may vary, even significantly, with respect to what has been illustrated herein purely by way of non-limiting example, without thereby departing from the sphere of protection, as defined by the annexed claims.

1. Cartridge with a filling of at least one substance for preparing a liquid product, said cartridge including a side wall, a first end wall through which said liquid product can flow from the cartridge and a second end wall of the cartridge at the opposite side with respect to said first end wall, wherein said side wall, said first end wall and said second end wall comprise compostable material,
wherein at least one between said first end wall and said second end wall has a layered structure comprising at least one layer of a first compostable material and at least one layer of a second compostable material,
wherein said at least one layer of a first compostable material comprises at least one compound selected between polybutyrate adipate terephthalate (PBAT) and polybutylsuccinate (PBS),
wherein said at least one layer of a second compostable material consists of at least one compound selected between polylactic acid (PLA) and a polyhydroxyalkanoate (PHA) polymer, wherein the polyhydroxyalkanoate (PHA) polymer is preferably polyhydroxybutyrate (PHB).

2. Cartridge according to claim 1, wherein said at least one layer of a second compostable material consists of PLA.

3. Cartridge according to claim 1, wherein said at least one layer of a first compostable material comprises, preferably consists of, a mixture of PBAT and/or PBS in combination with PLA.

4. Cartridge according to claim 1, wherein said at least one layer of a second compostable material is arranged internally of the cartridge with respect to said at least one layer of said first compostable material, and it is in contact with the substance for preparing the liquid product.

5. Cartridge according to claim 1, wherein the thickness of said at least one layer of a first compostable material is comprised between 50% and 80% of the total thickness of each one between said first end wall and said second end wall.

6. Cartridge according to claim 1, wherein the thickness of said at least one layer of a second compostable material is comprised between 20% and 50% of the total thickness of each one between said first end wall and said second end wall.

7. Cartridge according to claim 1, wherein the ratio between the thickness of said at least one layer of a first compostable material and the thickness of said at least one layer of a second compostable material is 4:1.

8. Cartridge according to claim 1, wherein at least one between said first end wall and said second end wall comprises at least one coating barrier layer to oxygen and water vapour sandwiched between said at least one layer of a first compostable material and said at least one layer of a second compostable material.

9. Cartridge according to claim 8, wherein said barrier coating layer comprises material selected from among metallization layers, silicon-based and/or silicon-oxide-based coatings, aluminium-based and/or aluminium-oxide-based coatings, polyvinyl alcohol (PVOH), butane-diol-vinyl alcohol co-polymer (BVOH), combinations thereof.
